(19) United States
(12) Patent Application Publication
(10) Pub. No.: US 2005/0029056 A1
(43) Pub. Date: Feb. 10, 2005

(54) Disc brake and method for determining the braking force of a disc brake

(76) Inventors: Johann Baumgartner, Moosburg (DE); Dirk Ganzhorn, Munchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/491,429

(22) PCT Filed: Sep. 27, 2002
(86) PCT No.: PCT/EP02/10853

(30) Foreign Application Priority Data
Oct. 1, 2001 (DE) 101-48-472.0

(51) Int. Cl. F16D 66/00

(52) U.S. Cl. 188/1.11 L

(57) ABSTRACT

The invention relates to disc brake comprising an actuator, which has a brake actuating lever and is located in a brake caliper and to a method for determining the braking force in braking operations using a disc brake. The invention is characterized in that at least one tension sensor is positioned at least on the brake actuation lever, on the brake actuator, on the brake caliper and/or on a brake anchor plate, said sensor being used to measure the tensions for determining the brake force. A location on the brake actuating lever is particularly suitable.

### BACKGROUND AND SUMMARY OF THE INVENTION

The invention relates to a disc brake having an actuator, which has a brake actuating lever and is arranged in a caliper, as well as to a method for determining the braking force in braking operations using a disc brake brake.

In the case of many different types of brakes, particularly in the case of pneumatically operated utility vehicle brakes, the braking force transmission takes place through the use of a brake actuating lever, which is operated by a piston rod of a brake cylinder. The brake actuating lever converts the force of the actuating unit (membrane cylinder, general actuator) at the transmission ratio of the brake actuating lever, or multiplies it with the transmission ratio, and thereby increases the braking force. A special advantage of such a lever system is the possibility of generating high braking forces by using only relatively low starting forces.

For controlling and/or regulating the braking forces, the pressure is analyzed, which pressure is applied at the pneumatic cylinder. This pressure is compared with a desired value, so that regulation can take place, as required. The regulation of the pressure is based on the presence of a pneumatic actuator, which is fed with compressed air.

In the case of brakes which hydraulically or electro-mechanically actuate the lever mechanism of the brake by way of an electric motor with a linear drive, the air pressure is eliminated as an advantageous regulating variable.

It is therefore an object of the invention to further develop a disc brake of the above-mentioned type, as well as the method of determining the braking force of the disc brake of the above-mentioned type, such that it can be used for disc brakes having many different types of construction, particularly in the case of disc brakes with many different actuators, for example, in a pneumatic, hydraulic or electromechanical construction.

With respect to the disc brake, the invention achieves this goal by arranging at least one measuring sensor, particularly a tension sensor, on at least one of the brake actuating lever, the brake actuator, the caliper and a brake anchor plate. And, with respect to the process of determining the braking force, tensions at least one of the brake actuating lever, the brake actuator, the caliper and on a brake anchor plate, from which tensions the application force exercised upon the brake or the braking torque is determined.

Advantageous constructions of the invention are described and claimed herein.

At least one measuring sensor, particularly a tension sensor, is arranged at least on the brake actuating lever, on the brake actuator, on the caliper and/or on a brake anchor plate. From the tension measurements, the braking forces are then determined, for example, by the use of a comparison and/or multiplication with previously stored reference values or constants. The invention starts with the idea of determining the braking force by way of tension measurements directly at the disc brake and, for implementing the measurement at the brake, suggests elements on this brake which are particularly suitable and which, so far, have not been utilized for measuring the braking force.

According to a particularly advantageous aspect of the invention, this measuring variable is more suitable for the measurement. The fewer elements that are situated between the measuring variable and the actual braking force is better, because each transmission element may be, in turn, faulty.

The measuring point or the element, at which the measuring takes place, should not be subject to wear because otherwise the measurements would supply different values in the course of the service life of the brake. Likewise, it is important that no outside environmental influences, such as dirt, moisture and mechanical influences, for example, thrown-up rocks, can contaminate the measuring point or even impair the operation. The measuring point should be selected in a suitable manner with respect to the high temperatures occurring during the braking operation. On the whole, a low susceptibility to trouble should be ensured in order to meet the demands on this safety-relevant part. The measuring point should therefore preferably be arranged in a protected environment inside the brake or the caliper.

Surprisingly, probably the most optimal measuring point was discovered to be the brake actuating lever of the brake. It is situated in the interior of the brake housing or brake caliper and is, therefore, protected from external influences. It is not subjected to wear and is designed for the entire service life of a brake. The force of the actuating unit is introduced at the brake actuating lever. The lever acts like a transverse beam, at which, corresponding to the load, tensile stress occurs on one side and compressive stress occurs on the other side. For this reason, at least one, preferably several tension sensors are arranged at the brake actuating lever.

Instead of the brake actuating lever, the caliper itself can also be utilized as the site of the measurement. During the operation of the brake, it expands as a result of the occurring reaction forces.

A cover housing for the caliper can be utilized as another suitable measuring point. The brake actuating lever is supported by way of bearings on the interior side of the cover housing or directly at the caliper, so that here the braking forces are introduced by way of the cover housing—in the case of a multi-part construction of the caliper with screwed connections—or directly into the caliper—in the case of a one-piece construction. Here, tensions are essentially proportional to the braking force and can be used as a measuring signal for controlling the brake.

The measuring variables can be evaluated by use of correspondingly mounted wire strain gauges or by use of piezo-electric elements, which are coupled with a measuring amplifier. The received signal is directly related to the braking force or to the braking torque and can, therefore, be used as a measuring variable for regulating the brake.

Depending on the measuring point, wire strain gauges can be switched to a quarter bridge, half bridge or full bridge, and can be evaluated by the use of a simple measuring amplifier.

Piezo elements, which are pressed into a bore at the measuring point, also supply a signal corresponding to the deformation of the part.

The mounting of the wire strain gauges can take place by various methods.

The wire strain gauges may be glued onto a surface. As an advantageous variant, the wire strain gauges are applied to a metal carrier plate. Even under more unfavorable conditions, such as dirt, moisture, and the like, which may occur at the assembly line, the metal plate can then easily be welded to the measuring point. This permits an industrial production of brake actuating levers with wire strain gauges.

In contrast, the piezo elements are preferably pressed into a bore. However, for this purpose, only one bore with a defined tolerance field is required. The production can therefore take place without any problems.

Although it is known from German Patent Document DE 196 40 901 C2 to measure an elastic deformation of the application device on an electro-mechanical brake actuator by the use of a sensor, from which deformation the exercised application force is determined, this system has the disadvantage that the actuator and the operating unit represent a unit which cannot be separated. When the actuator is exchanged for an operating unit of another operating principle, the sensor is therefore eliminated. Here, the invention provides a remedy in a simple manner.

In the following, the invention will be explained in detail by means of an embodiment.

### BRIEF DESCRIPTION OF THE DRAWINGS

FIG. 1 is a top view of a first disc brake having a construction according to the invention;

FIGS. 2a, b are rear views of a second and a third disc brake, respectively, having constructions according to the invention;

FIG. 3 is a sectional view of a fourth disc brake having a construction according to the invention;

FIG. 4 is a top view of the disc brake according to FIG. 3;

FIGS. 5a-5c and 6a-6c are respective views of brake actuating levers for the disc brake according to FIG. 3;

FIG. 7 is a view of a brake anchor plate of a fifth disc brake according to the invention;

FIG. 8 is a schematic diagram of a measuring circuit for the brakes according to FIGS. 1 to 7; and

FIGS. 9a and 9b are diagrams which illustrate the proportional relationship between the braking force and the determined wire strain gauge signal through the use of measurements at the brake actuating lever, as well as at the caliper.

### DETAILED DESCRIPTION OF THE DRAWINGS

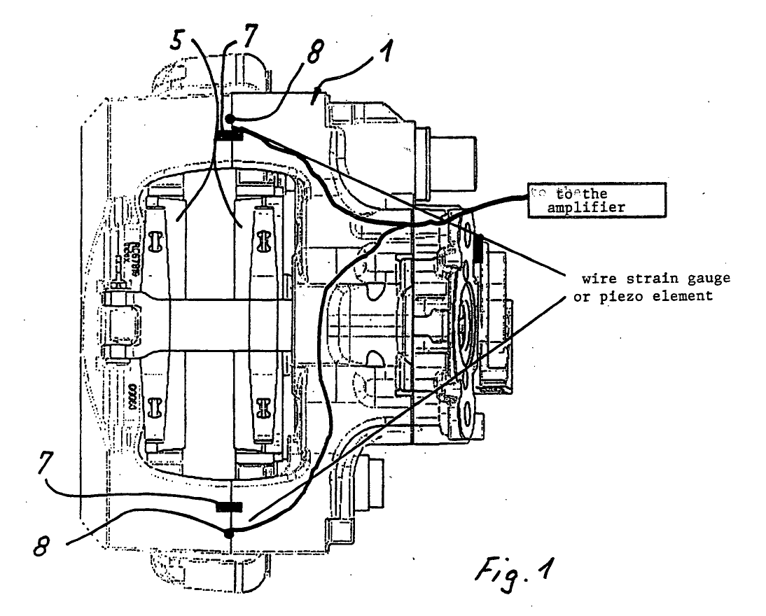

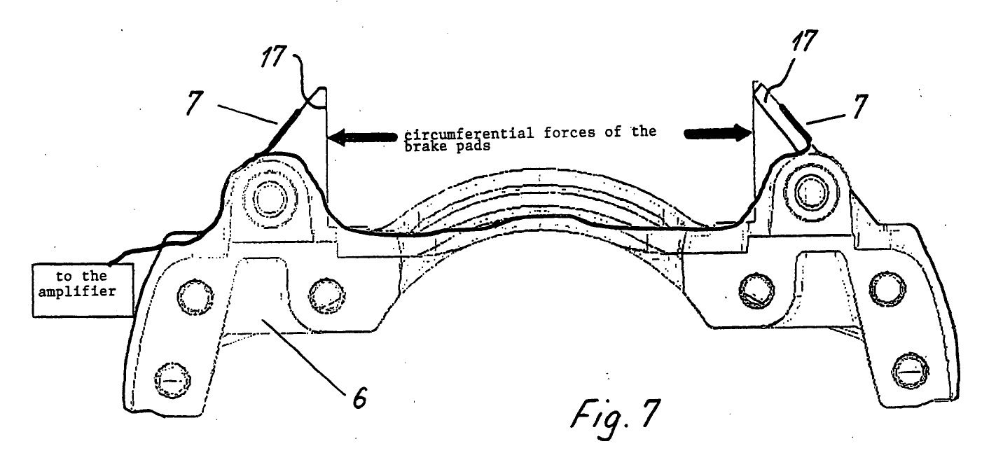

FIGS. 1 and 3 each show a disc brake having a caliper 1 which straddles a brake disc 2 (not shown here), in which case, a brake application device having an adjuster 3 (for example, an electric wear adjuster) is arranged on one side of the caliper. A brake actuating lever 4 is acted upon by a piston rod of a brake cylinder, which piston rod is not shown. The adjuster is used for advancing the brake pads 5 in the direction of the brake disc 2 for wear adjustment. By means of the brake anchor plate 6, the caliper 1 is displaceably disposed on a wheel axle (FIG. 7).

According to the invention, a suitable measuring variable for the braking force is provided, particularly for such brakes, in which case the brake application device can be operated according to different operating principles, for example, pneumatically, electromechanically or hydraulically.

One possibility of implementing the measurement is represented by the caliper 1. FIG. 1 illustrates this embodiment. In the area in which the reaction forces are transmitted from the side of the caliper receiving the brake application device to the reaction side—for example, in the area reaching over the brake disc—wire strain gauges 7 (black rectangles) or piezo elements 8 (black circles) are applied to the caliper 1. At least one wire strain gauge or one piezo element is provided; advantageously, several of the wire strain gauges 7 or of the piezo elements 8 are distributed on the caliper 1.

An asymmetrical stressing may occur at the caliper 1 as a result of diagonal wear at the brake pads. It therefore also makes sense to absorb the tensions, as required, on both sides of the caliper 1 and to ascertain the mean value. One advantage of this arrangement is also the direct measuring of the braking force without mechanical intermediate links, which may exhibit a hysteresis effort.

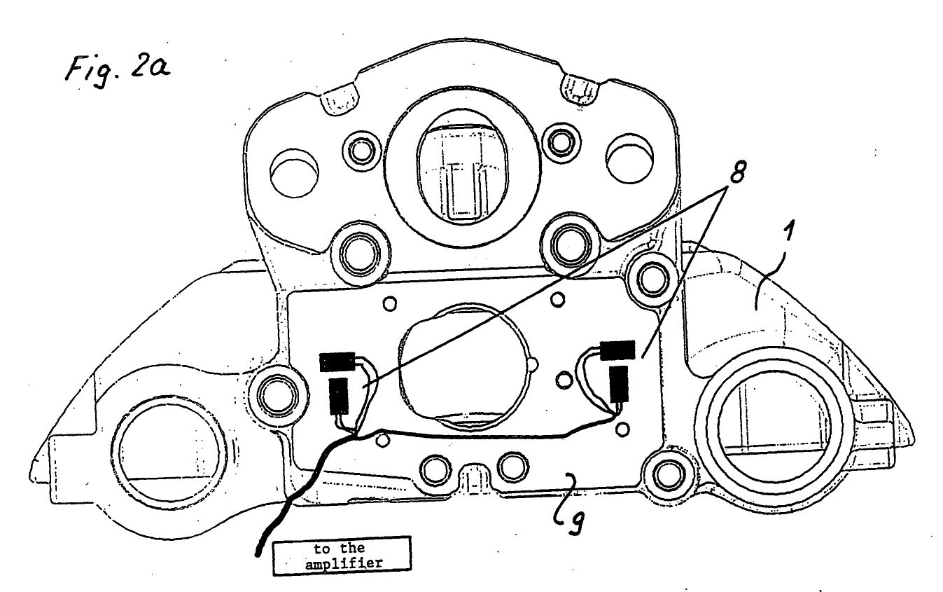

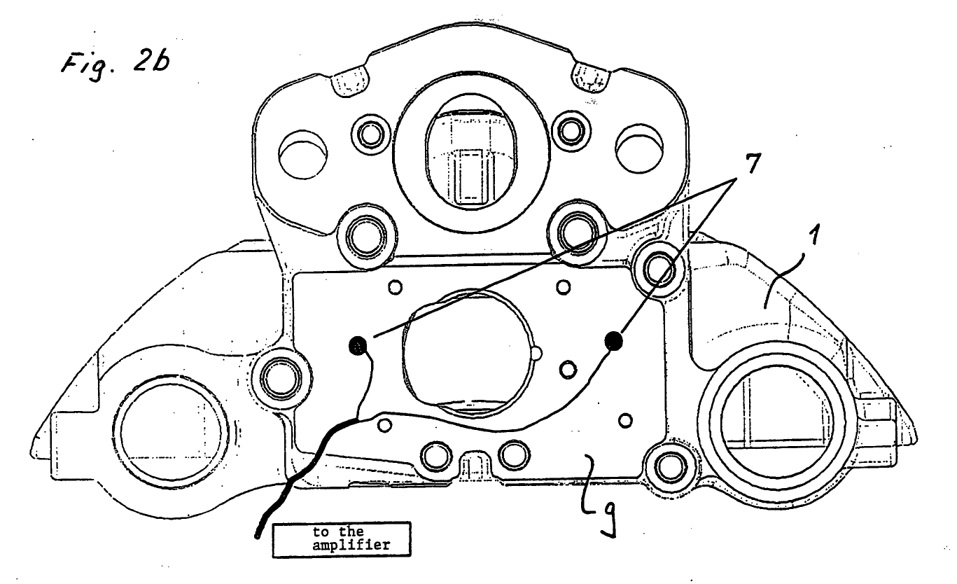

As an alternative, or in addition, the wire strain gauges 7 or the piezo elements 8 may also be arranged in the area of the caliper 1 facing away from the brake disc or in the interior or exterior area of a cover housing 9 (may also correspond to a second caliper part) (FIGS. 2a and 2b).

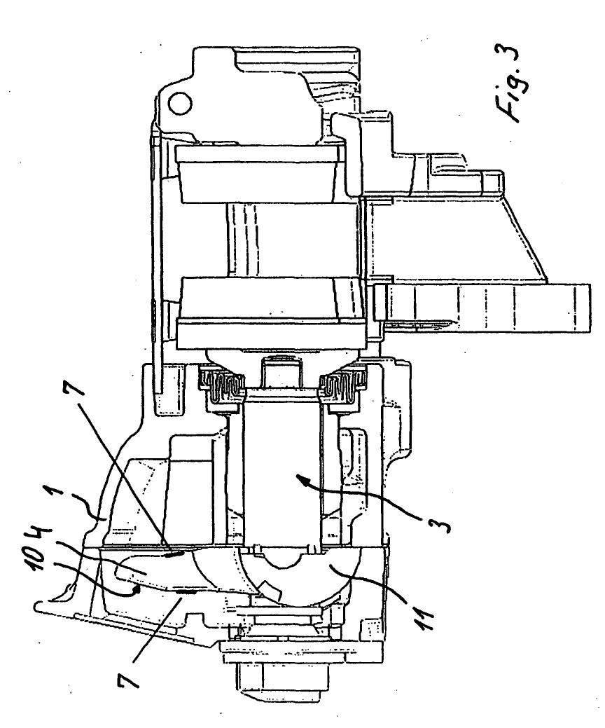

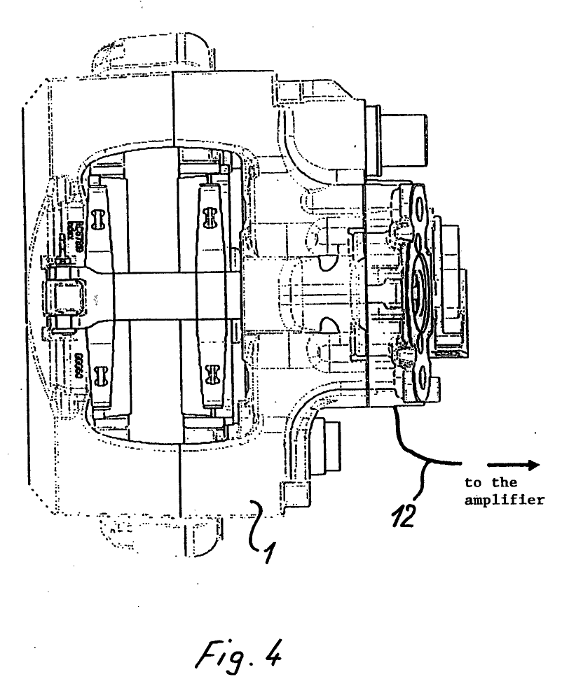

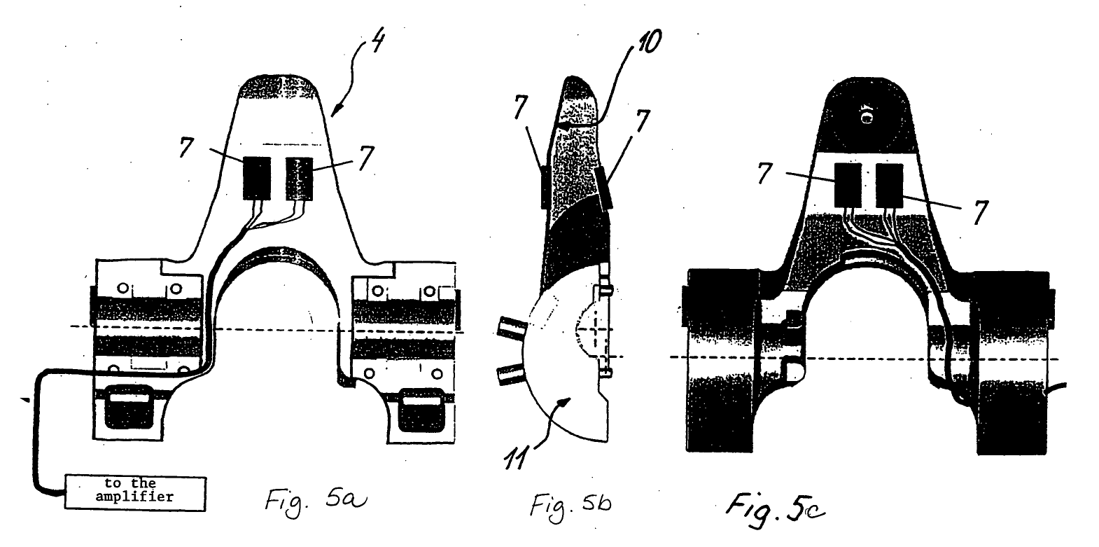

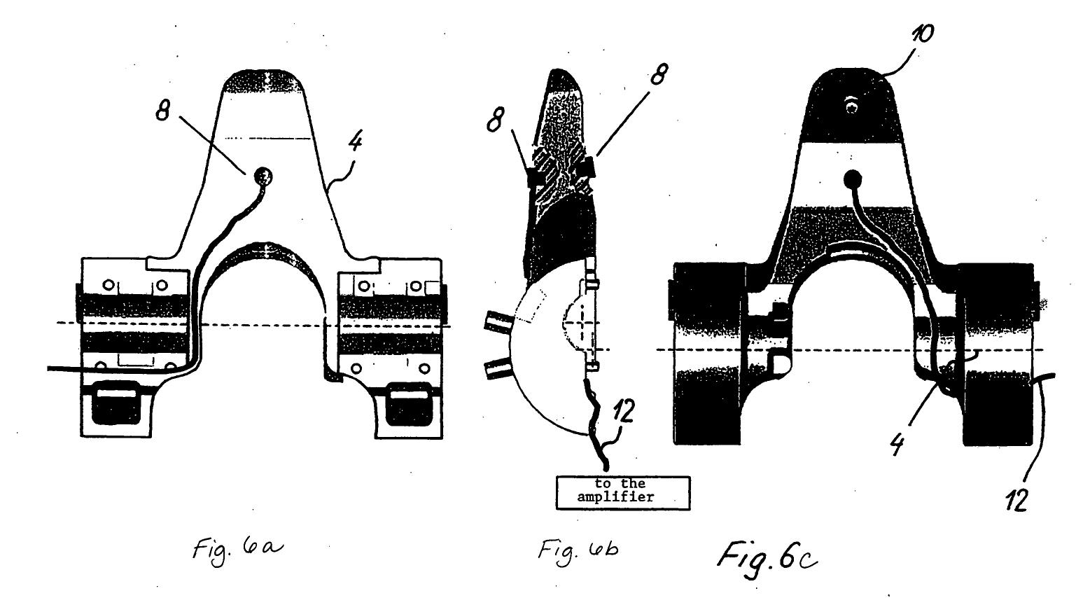

According to FIGS. 3 to 6, the wire strain gauges 7 or the piezo elements 8 are arranged as an alternative and/or in addition to the above-mentioned embodiments on the brake actuating lever 4, specifically preferably between the recess 10 for the piston rod on the top end of the brake actuating lever 4 and the lower eccentric-type section 11 of the brake actuating lever 4.

Preferably, the wire strain gauges 7 and/or the piezo elements 8 (see FIGS. 3, 5 and 6) are also, in each case, arranged on the surface of the brake actuating lever 4 facing the brake disc and on the surface facing away from the brake disc.

In addition or as an alternative, FIG. 7 shows an embodiment in which the braking torque measurement takes place by the use of wire strain gauges 7 or piezo elements 8 arranged on the brake anchor plate (carrier) and there preferably by using wire strain gauges 7 and piezo elements 8 arranged on the horns of the brake anchor plate.

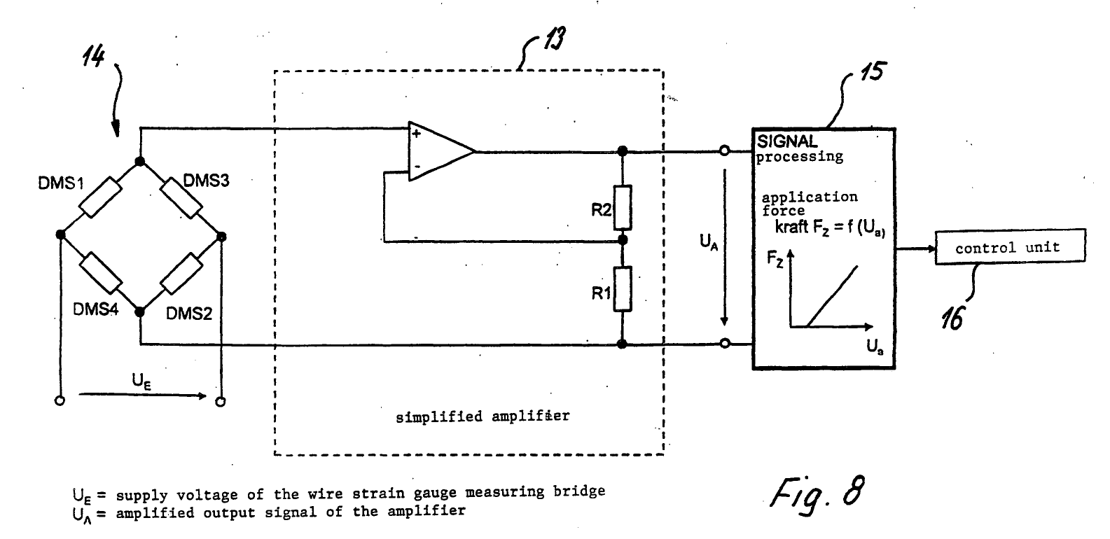

By way of a cable 12 connected to the brake actuating levers 4 and/or to the caliper 1 or another suitable element—if required, together with additional data and/or voltage supply lines, the measuring signal can be fed to a measuring circuit as illustrated in FIG. 8.

By mounting one to four wire strain gauges on the front side and/or the back side of the brake actuating lever 4, a quarter, half, or full bridge can be implemented for analyzing the occurring tensions on the brake actuating lever 4.

The measuring circuit has a measuring bridge 14 consisting of four wire strain gauges, each forming one resistor RDMS1, RDMS2, RDMS3, RDMS4 respectively, to which a measuring voltage UE is applied. If required, the measuring bridge according to FIG. 8 is supplemented to a full bridge by the amplifier 13 which can be designed as a miniature amplifier. The output signal of the measuring bridge 14 is fed to an amplifier 13 whose output signal is a tension value which is proportional to the braking force. If required, this value is fed to a signal processing unit 15 and from there is fed to a brake control unit 16 for evaluation (for example, to an EBS control unit).

As a miniature amplifier, the amplifier 13 can advantageously be integrated in the brake. The cable 12 then only has to have two supply cables with a feed voltage and two lines for the measuring signal. Likewise, it is contemplated to integrate the amplifier 13 into the back side of the wire strain gauge 7.

When measuring using two and, even better, four wire strain gauges 7, the influence of temperature on the measurement can also be eliminated.

The amplifier 13 can also be integrated directly (not shown) in the brake actuating lever 4. As a result, the lines to the amplifier can be kept short and the disturbances with respect to the measuring signal are reduced. As an alternative, the signal can be transmitted to the outside in a contactless manner by way of a transmitter on the back side of the brake actuating lever 4. This has the advantage that no lines have to be laid from the moving brake actuating lever 4 to the stationary caliper 1. In this case, the energy supply of the measuring system takes place in a contactless manner.

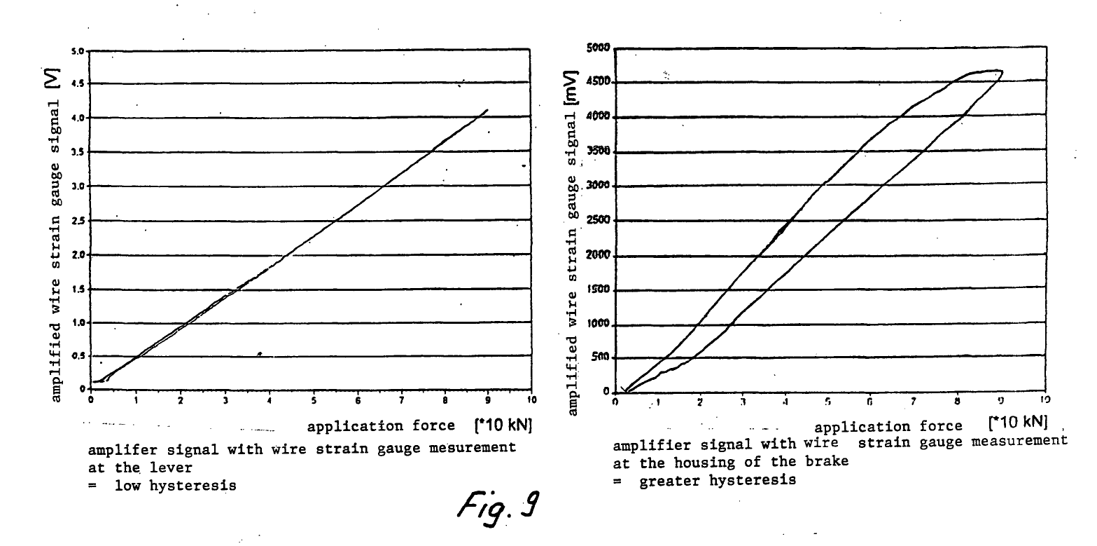

For controlling the brake, a relationship has to be found between the measuring signal and the braking force. When measuring the tensions at the brake actuating lever 4, a relationship according to the type of FIG. 9 is obtained which is essentially linear and can be prestored in a data memory. As a result, a braking force which is required for controlling and regulating the brake can clearly be assigned to a measuring signal. The suitability of the brake actuating lever 4 for the measurement becomes particularly clear.

### Table of Reference Numbers

Caliper 1
brake disc 2
adjuster 3
brake actuating lever 4
brake pads 5
brake anchor plate 6
wire strain gauge 7
piezo elements 8
cover housing 9
recess 10
eccentric-type section 11
data line 12
amplifier 13
measuring bridge 14
signal processing unit 15
control 16
brake anchor plate horns 17

1-21. (cancelled).

22. A disc brake, comprising:
a caliper;
a brake anchor plate supporting the caliper;
a brake application device having a brake actuating lever arranged in the caliper;
at least one tension sensor positioned on at least one of the brake actuating lever, the brake application device, the caliper, and the brake anchor plate, the at least one tension sensor measuring tension for determining a braking force.

23. The disc brake according to claim 22, further comprising a measuring circuit coupled to the at least one tension sensor, the measuring circuit analyzing tension signals from the at least one sensor.

24. The disc brake according to claim 22, wherein the tension sensor has at least one wire strain gauge.

25. The disc brake according to claim 24, wherein the tension sensor has several wire strain gauges.

26. The disc brake according to claim 22, wherein the tension sensor has at least one piezo element.

27. The disc brake according to claim 26, wherein the tension sensor has several piezo elements.

28. The disc brake according to claim 22, wherein the tension sensor includes at least one wire strain gauge or piezo element arranged on the brake actuating lever.

29. The disc brake according to claim 28, wherein several wire strain gauges or several piezo elements are arranged on the brake actuating lever.

30. The disc brake according to claim 22, wherein the brake actuating lever has a recess at one end adapted to accommodate a piston rod of a brake cylinder and has a lower eccentric section at another end; and wherein the tension sensor includes at least one of a wire strain gauge and a piezo element arranged between the recess and the lower eccentric section.

31. The disc brake according to claim 22, wherein the tension sensor includes at least one wire strain gauge or piezo element distributed on a surface of the brake actuating lever that at least one of faces away from and faces toward a brake disc when in use.

32. The disc brake according to claim 22, wherein the tension sensor includes at least one wire strain gauge or piezo element arranged on an area of the caliper that straddles over the brake disc when in use.

33. The disc brake according to claim 32, wherein the tension sensor includes at least one wire strain gauge or piezo element arranged on a reward area of the caliper facing away from the brake disc when in use.

34. The disc brake according to claim 22, wherein the tension sensor includes at least one wire strain gauge or piezo element arranged on a separate cover housing forming part of the caliper.

35. The disc brake according to claim 22, wherein the tension sensor includes at least one wire strain gauge or piezo element arranged on horns of the brake anchor plate.

36. The disc brake according to claim 24, wherein the at least one wire strain gauge is arranged on a metal carrier plate adapted to be welded onto a measuring point of the disc brake.

37. The disc brake according to claim 24, wherein the at least one wire strain gauge is glued onto the disc brake.

38. The disc brake according to claim 26, wherein the at least one piezo element is pressed into bores formed in the disc brake with a defined fit.

39. The disc brake according to claim 23, wherein the measuring circuit comprises a measuring bridge in which a respective wire strain gauge forms resistors thereof.

40. The disc brake according to claim 23, wherein the measuring circuit includes an amplifier coupled to at least one of the wire strain gauges piezo element tension sensors and a measuring bridge.

41. The disc brake according to claim 40, wherein the amplifier is attached to at least one of the caliper, the brake anchor plate and the brake actuating lever.

42. The disc brake according to claim 23, wherein the measuring circuit includes a signal processing unit.

43. The disc brake according to claim 23, wherein the measuring circuit is coupled with a brake control unit.

44. The disc brake according to claim 23, wherein the measuring circuit is coupled via one of a data line, an IR path, and a radio path with a brake control unit.

45. The disc brake according to claim 40, wherein the amplifier is a miniature amplifier.

46. A method for determining a braking force in braking operations of a disc brake, the method comprising the acts of:
measuring tensions on at least one of a brake actuating lever, a brake actuator, a caliper, and a brake anchor plate of the disc brake; and
determining the braking force based upon the measured tensions.

47. A braking force determination device for use with a disc brake having a caliper, a brake actuating device having a brake actuating lever, and a brake anchor plate supporting the caliper, the device comprising:
a plurality of tension sensors adapted to be positioned on at least one of the brake actuating lever, the brake application device, the caliper and the brake anchor plate, said plurality of tension sensors generating tension signals;
a measuring circuit formed of the plurality of tension sensors, the measuring circuit providing a measured value output; and
a signal processing unit coupled with the measuring circuit for processing the measured value output to determine the braking force.

48. The braking force determination device according to claim 47, further comprising a brake control unit coupled to the signal processing unit.

49. The braking force determination device according to claim 48, wherein the brake control circuit is wirelessly coupled to the measuring circuit.
